(19) United States
(12) Patent Application Publication
(10) Pub. No.: US 2024/0271723 A1
(43) Pub. Date: Aug. 15, 2024

(54) CONNECTING APPARATUS AND SUSPENSION ASSEMBLY

(71) Applicant: GRIPPLE LIMITED, Sheffield, South Yorkshire (GB)

(72) Inventors: Simon Davis, Sheffield, South Yorkshire (GB); Samuel White, Sheffield, South Yorkshire (GB); Oliver Sunderland, Sheffield, South Yorkshire (GB)

(21) Appl. No.: 18/567,245

(22) PCT Filed: Jun. 24, 2022
(86) PCT No.: PCT/IB2022/055874

§ 371 Date: Dec. 5, 2023

(30) Foreign Application Priority Data
Jun. 28, 2021 (GB) 2109262.2
Jun. 28, 2021 (GB) 2109264.8
Jun. 23, 2022 (GB) 2209226.6
Jun. 23, 2022 (GB) 2209230.8

(51) Int. Cl. F16L 3/133; F16B 2/14; F16B 2/16

(52) U.S. Cl. CPC F16L 3/133; F16B 2/14; F16B 2/16

(57) ABSTRACT

A connecting apparatus comprises a support member (12) and a securing arrangement (16) to secure the support member (12) to an elongate member (14). The securing arrangement (16) comprises a clamping arrangement comprising a body (36) having an internal converging wall arrangement (42). The converging wall arrangement (42) defines a passage (44) for receiving the elongate member (14) therethrough. The clamping arrangement further includes a clamping member (48) in the passage (44). The clamping member (48) is movable along the passage (44) in a clamping direction to clamp the elongate member (14).

This invention relates to connecting apparatus. This invention relates to suspension assemblies. More particularly, but not exclusively, this invention relates to connecting apparatus for use in suspension assemblies.

It is known to suspend pipes and cable trays from roofs or ceilings by means of support members, such as brackets or struts, fastened to smooth or threaded rods. The attachment of the support members to the rods requires nuts to be screwed onto the rods. This can be time consuming.

According to a general aspect of this invention, there is provided a connecting apparatus comprising:
a support member; and
a cartridge mounted on the support member, the cartridge comprising a fastening arrangement for connecting an elongate suspension member to the support member.

The cartridge may include a housing for the fastening arrangement.

According to one aspect of this invention, there is provided a fastening arrangement comprising:
a clamping arrangement comprising a body having an internal converging wall arrangement, the converging wall arrangement defining a passage for receiving an elongate suspension member therethrough;
the clamping arrangement further including a clamp member in the passage;
wherein the clamp member is movable along the passage in a clamping direction to clamp the elongate suspension member.

According to another aspect of this invention, there is provided a connecting apparatus comprising:
a support member; and
a fastening arrangement to fasten the support member to an elongate suspension member;
wherein the fastening arrangement comprises a clamping arrangement comprising a body having an internal converging wall arrangement, the converging wall arrangement defining a passage for receiving an elongate suspension member therethrough;
the clamping arrangement further including a clamp member in the passage;
wherein the clamp member is movable along the passage in a clamping direction to clamp the elongate suspension member.

According to another aspect of this invention, there is provided a suspension assembly comprising a connecting apparatus as described above and an elongate suspension member.

The support member may be for supporting an article. The fastening arrangement may be received in the support member. The fastening arrangement may be received in an end region of the support member.

The connecting apparatus may include a cartridge. The suspension assembly may include a cartridge. The cartridge may comprise the fastening arrangement. The cartridge may include a housing in which the clamping arrangement is housed.

The connecting apparatus may comprise two of the fastening arrangements. Each of the fastening arrangements may be received in a respective opposite end region of the support member. Alternatively, the connecting apparatus may be receivable in a further support member to provide the suspension assembly. The connecting apparatus may be receivable in one end region of the further support member. A further connecting apparatus may be receivable in an opposite end region of the further support member.

According to another aspect of this invention, there is provided a suspension assembly comprising:
a support member for supporting an article;
an elongate suspension member; and
a fastening arrangement to fasten the support member to the elongate suspension member;
wherein the fastening arrangement comprises a clamping arrangement comprising a body having a converging wall arrangement, the converging wall arrangement defining a passage for receiving an elongate suspension member therethrough;
the clamping arrangement further including a clamp member in the passage;
wherein the clamp member is movable along the passage in a clamping direction to clamp the elongate suspension member.

The support member may be a support, such as a strut, bar, beam or bracket.

The clamping arrangement may be a clamp mechanism. The connecting apparatus may be a connector. The fastening arrangement may be a fastener.

According to another aspect of this invention, there is provided a fastener comprising:
a clamp mechanism comprising a body having an internal converging wall arrangement, the converging wall arrangement defining a passage for receiving an elongate suspension member therethrough;
the clamp mechanism arrangement further including a clamp member in the passage;
wherein the clamp member is movable along the passage in a clamping direction to clamp the elongate suspension member.

According to another aspect of this invention, there is provided a connector comprising:
a support; and
a fastener to fasten the support to an elongate suspension member;
wherein the fastener comprises a clamp mechanism comprising a body having an internal converging wall arrangement, the converging wall arrangement defining a passage for receiving an elongate suspension member therethrough;
the clamp mechanism further including a clamp member in the passage; wherein the clamp member is movable along the passage in a clamping direction to clamp the elongate suspension member.

According to another aspect of this invention, there is provided a suspension assembly comprising:
a support for supporting an article;
an elongate suspension member; and
a fastener to fasten the support to the elongate suspension member;
wherein the fastener comprises a clamp mechanism comprising a body having a converging wall arrangement, the converging wall arrangement defining a passage for receiving an elongate suspension member therethrough;
the clamp mechanism further including a clamp member in the passage;
wherein the clamp member is movable along the passage in a clamping direction to clamp the elongate suspension member.

The support member may be configured to support the article. The fastening arrangement may fasten the elongate suspension member thereto. The suspension assembly may comprise two of the fastening arrangements. Each fastening arrangement may be received in a respective end region of the support member.

The clamping direction may be a direction towards the inward converging of the wall arrangement. The fastening arrangement may comprise an urging member to urge the clamp member in the direction of the inward converging of the wall arrangement. The movement of the clamp member in the direction of the inward converging of the wall arrangement may cause the clamp member to clamp the elongate suspension member in the passage.

The fastening arrangement may comprise a plurality of the clamp members, such as two or three. Alternatively, the fastening arrangement may comprise a single clamp member. The urging member may urge the, or each, clamp member in the direction of the inward converging of the wall arrangement. The movement of the plurality of clamp members in the direction of the inward converging of the wall arrangement may cause the, or each, clamp member to clamp the elongate suspension member in the passage.

The, or each, clamp member may comprise a ball, roller, wedge or the like. For example: in the first embodiment, the clamp member may comprise a ball; in the second embodiment, the clamp member may comprise a roller. In the third embodiment, the clamp member may comprise a wedge.

The fastening arrangement may comprise a carriage in which the, or each, clamp member is carried.

The carriage may be movable along the passage in the direction of the inward converging of the wall arrangement. The urging member may urge the carriage in the direction of the inward converging of the wall arrangement.

The fastening arrangement may include the carriage.

Each of the plurality of clamp members may be carried by the carriage. In the second embodiment, the clamp member may be carried by the carriage. Where the second embodiment has more than one of the clamp members, the carriage may carry each of the clamp members.

The clamping arrangement may be housed in the body. The carriage may be housed in the body. The urging member may be housed in the body. The fastening arrangement may comprise a cartridge. The body may comprise the wall arrangement.

The carriage may include a holding member to hold the clamp member. The holding member may define a recess to receive the clamp member. The carriage may define a plurality of the recesses, wherein each recess holds a respective clamp member. The holding member may be substantially C-shaped, defining said recess.

The fastening arrangement may comprise a housing in which the clamping arrangement is housed. The carriage may be housed in the housing. The urging member may be housed in the housing. The fastening arrangement may comprise a cartridge.

A reaction member may be provided to apply a reaction force to the urging member. The reaction member may be disposed at one end of the passage.

The carriage may define a through bore. When the elongate suspension member is received through the passage, the elongate suspension member may extend through the bore.

The body may have a main part and a flange portion on the main part. The flange portion may engage an end of the support member. The body of the first embodiment may comprise the main part and the flange portion.

The fastening arrangement may include the reaction member to provide a reaction for the carriage. The reaction member may be disposed on the body at one end of the passage.

The reaction member may be a reaction formation of the support member. Two of the reaction members may be provided. Each of the reaction members may be one of the reaction formations.

The body may define substantially opposite first and second openings to provide communication between the passage and a region external of the body. The reaction member may extend across the first opening.

The passage may have a holding region for holding the reaction member. The holding region may be cylindrical.

The clamping arrangement may comprise a clamping component. The clamping component may include the wall arrangement. The clamping component may further include the clamp member. The clamping component may further include the urging member. The body may comprise the housing for housing the clamping component.

The main part of the body may comprise the clamping component and the housing.

The housing may comprise first and second housing portions. The first housing portion may receive a first region of the wall arrangement. The second housing portion may receive a second region of the wall arrangement. The first housing portion may comprise an upper housing portion. The second housing portion may comprise a lower housing portion.

The housing may define the opposite first and second openings. The first housing portion may define the first opening. The second housing portion may define the second opening. The passage may be aligned with the first and second openings.

The first opening may be offset from the second opening. The first clamping wall portion may have a first inner surface. The second clamping wall portion may have a second inner surface.

The second inner surface may extend substantially perpendicular to the central support portion. The first inner surface may extend from the first opening to the second opening. The first inner surface may slope relative to the central support portion.

In the third embodiment, the housing may comprise the reaction member. The second housing portion may comprise the reaction member. The reaction member may be arranged adjacent the second opening in the housing.

The housing may further include cooperating affixing formations for affixing the first and second housing portions to the wall arrangement. The affixing formations may comprise snap fit formations.

The snap fit formations may comprise resilient hook members, which may be provided on each of the first and second housing portions. The wall arrangement may define depressions. The resilient hook members may be received by the depressions.

The wall arrangement may comprise opposite edges. The opposite edges may define the depressions. The first and second housing portions may define opposite edges. The resilient hook members may project from the first and second portions. The resilient hook members may be received in the depression when the wall arrangement is received in the first and second housing portions.

The main part may receive the clamping component. The main part may define a recess to receive the clamping component. Desirably, the main part may receive the clamping component when the clamping component is housed by the housing.

The main part may have a compartment, which may extend downwardly. The main part may define an outer opening through which the elongate suspension member may extend when the elongate suspension member is received through the passage. The outer opening may be defined by the compartment. The outer opening may be aligned with the first opening. The region of the receptacle defining the outer opening may be contiguous with the region of the first housing portion defining the first opening.

The body of the third embodiment may comprise the flange portion on the main part. The body and the support member may further include a locking arrangement for locking the body to the support member. The locking arrangement may comprise a snap-fit member, which may be receivable in a hole or depression, thereby locking the body to the support member. The body may comprise the snap-fit member. The hole or the depression may be defined in the support member.

The urging member may be disposed between the reaction member and the clamp member. The urging member may be disposed between the reaction member and the, or each, clamp member.

The urging member may be disposed between the reaction member and the carriage. The urging member and the carriage may be integral with each other.

In the third embodiment, the urging member may extend from the reaction member. The urging member may extend to the clamp member.

The housing may include a locating member for locating the urging member on the reaction member. The locating member may comprise a lug on the reaction member. The urging member may engage over the lug.

The urging member may comprise a spring, which may be a coil spring, or any other suitable type of spring, such as a leaf spring. The lug may be received by the spring to locate the spring on the reaction member.

The wall arrangement may converge towards the second opening. The wall arrangement may have a clamping region in which the clamp members may clamp the elongate suspension member. The clamping region may converge from the holding region towards the second opening. The urging member may urge the carriage towards the second opening.

The wall arrangement may have opposite clamping wall portions. The clamp member may clamp the elongate suspension member between the opposite clamping wall portions.

The opposite clamping wall portions may comprise a first clamping wall portion for engaging the elongate suspension member, and a second clamping wall portion for urging the clamp member into clamping engagement with the elongate suspension member.

In the second embodiment, the second clamping wall portion may engage the holding portion of the carriage to effect clamping of the elongate suspension member by the clamp member.

The first and second clamping wall portions may converge towards each other from the first opening to the second opening. The second clamping wall portion may converge towards the first clamping wall portion. The second clamping wall portion may extend at an acute angle to the first clamping wall portion.

In the third embodiment, the wall arrangement may comprise a connecting wall portion extending between the first and second clamping wall portions.

The carriage may comprise an attaching portion extending from the urging member. The attaching portion may extend from the urging member to the holding member. The attaching portion may be substantially flat.

The attaching portion may engage the second clamping wall portion. The attaching portion may extend along the second clamping wall portion. The attaching portion may engage with the second clamping wall portion along the length of the attaching portion.

The fastening arrangement may include a release portion for releasing the, or each, clamp member from clamping the elongate suspension member. The release portion may comprise a release button.

The release portion may project from the carriage. The release portion may extend from the attaching portion.

In the first embodiment, the release portion may comprise a portion of the carriage extending through the second opening. The user may press the release portion towards the body, thereby moving the carriage in a direction opposite to the clamping direction.

In the second embodiment, the release portion may comprise a slidable button, which may be slidable along the second clamping wall portion. The release portion may extend through one of the opposite clamping wall portions.

The second clamping wall portion may define a slot through which the release portion may extend. The user may press the release portion along the clamping wall portion, thereby moving the carriage in a direction opposite to the clamping direction.

The urging member may be a resilient urging member. The resilient urging member may comprise a resilient portion and a foot portion. The foot portion may engage the reaction member. The resilient portion may extend between the foot portion and the carriage. The resilient portion may extend to the attaching portion.

The elongate suspension member may comprise a rod. The rod may be a cylindrical rod. The rod may be smooth or threaded. Alternatively, in the first embodiment, the elongate suspension member may comprise a wire, wire rope, cable, or the like. Alternatively, the elongate suspension member may be a substantially flat elongate suspension member, such as a strap.

The elongate suspension member may have a suspending portion to be clamped by the clamp member. The suspending portion may be substantially flat. The elongate suspension member may comprise a strap.

The suspending portion may have a longitudinal main axis. The first clamping wall portion may extend substantially parallel to the main axis of the suspending portion. The second wall portion may converge towards the suspending portion of the elongate suspension member.

The elongate suspension member may have a fastening portion at one end of the elongate suspension member.

In the third embodiment, the elongate suspension member may comprise a flexible elongate suspension member, such as a wire, wire rope strand, cable, or the like. Alternatively, the elongate suspension member may comprise a rod, which may be a smooth or threaded rod. Alternatively, the elongate suspension member of the third embodiment may comprise a substantially flat member such as a strap.

In the first embodiment, the fastening portion may comprise threads. The fastening arrangement may fasten the elongate suspension member to an upper member, such as a ceiling or a roof member.

In the second embodiment, the fastening portion may extend transverse to the suspending portion. The fastening portion may be provided to allow the elongate suspension member to be fastened to an upper member, such as a ceiling or a roof member. The fastening portion may cooperate with a suitable fastener, such as a screw or a nail to fasten the elongate suspension member to the upper member.

The opposite end of the elongate suspension member may taper to allow the elongate suspension member to be inserted into the passage.

In the third embodiment, an upper region of the elongate suspension member may be fastened to an upper member by the use of, for example a ceiling anchor, such as disclosed in GB2492203A. Alternatively, the elongate suspension member may be looped around the upper member, and the looped portion fastened to the main portion by a clamping device.

The suspension assembly of each embodiment may comprise two of the elongate suspension members, two of the fastening arrangements and a single support member.

The support member may have a central support portion and a side support portion arranged transverse to each other. The central support portion may define an aperture through which the elongate suspension member can be inserted when the support member is in a first orientation.

The side support portion may define a second aperture through which the elongate suspension member can be inserted when the support is in a second orientation.

The support member may have a return portion on a free edge of each of the side support portions. Each reaction formation may comprise the return portion. In the second embodiment, each reaction formation may be the return portion on each of the side support portions. The return portions may extend along each of the free edges. The return portions may extend along the whole length of each of the free edges.

The body may rest on the return portions when the support member receives the body. In the third embodiment, the compartment may be disposed between the return portions.

The central support portion may define two of the apertures. The central support portion may have opposite ends. The two apertures may be defined at respective opposite ends of the central support portion.

Alternatively, the support member may be tubular. The support member may have first and second central supports opposite one another. The reaction formation may be the second central support. The second central support may define two apertures opposite the apertures defined by the first central support.

The side support portion may define two of the second apertures. The side support portion may have opposite ends. The two second apertures may be defined at respective opposite ends of the side support portion.

The support member may have two of the side support portions, each side support portion extending from a respective opposite edge of the central support portion. Each side support portion may define a respective second aperture.

Each of the central and side support portions may be substantially planar. Each side support portion may define two of the second apertures. The second apertures may be defined at opposite ends of the respective side support portion.

The support member may have an end region. The end region may define a space to receive the fastening arrangement. The support member may have opposite end regions. Where the suspension assembly or connecting apparatus has two of the fastening arrangements, each end region may define a space to receive a respective one of the fastening arrangements.

In an alternative embodiment, in which the carriage comprises a through bore, the fastening arrangement may include a clamp member held by the carriage. The fastening arrangement may include a plurality of the clamp members. The, or each, clamp member may be a ball.

The carriage may define a through bore. The fastening arrangement may include a barrel member. The barrel member may have an inner converging wall arrangement.

The wall arrangement may define a narrowing gap. The spring may urge the carriage into the narrowing gap.

The barrel member may define a space in which the carriage is received. The barrel member may define a hole aligned with the bore.

The clamp member may be arranged in the carriage in around the bore. The clamp members may be held in place by the barrel member. The clamp members may be arranged in an equispaced array around the carriage.

The housing may have an outer part and an inner socket. The carriage may be received in the socket. The barrel member may be received in the socket. The socket may define an aperture aligned with the hole and the bore.

A reaction member may be provided. The reaction member may secure the carriage within the housing. The urging member may be disposed on the reaction member between the reaction member and the carriage. The reaction member may comprise a platform on which the urging member is disposed.

The reaction member may comprise affixing members to affix the reaction member to the housing. The affixing members may be clips. The clips may be snap fit clips. The clips may be received in slots defined by the housing.

The elongate suspension member may be received by the carriage through the bore. The elongate suspension member may be a flexible elongate suspension member, such as a wire, wire rope, cable or the like. Alternatively, the elongate suspension member may be a rod, such as a smooth rod or a threaded rod.

The elongate suspension member may be received through the bore in the carriage and through the hole and the aperture.

The urging of the carriage into the narrowing gap may push the, or each, clamp member into clamping engagement with the elongate suspension member.

The carriage may have a release portion configured to release the, or each, clamp member from clamping the elongate suspension member. The release portion may comprise an end region of the carriage. The release portion may protrude from the aperture. The release portion may be cylindrical.

The release portion may extend through the hole in the barrel member when the elongate suspension member is clamped by the, or each, clamp member.

The fastening arrangement may further include an actuating element for pressing the release portion. The actuating element may be received in the housing through an opening in the housing.

The actuating element may comprise a projection on each of the opposite sides of the actuating element. The housing may define a slot in each of the opposite sides of the housing. The actuating element may be slidably received in the housing. The actuating element may be secured in the housing by the receipt of each projection in a respective one of the slots. The projections may slide within the slots when the actuating element slides within the housing.

The actuating element may comprise a push member, which may be in the form of a button. The actuating element may further include a support. The support may be substantially flat. The support may extend transverse to the push member. In use, the support may be arranged substantially horizontally and the push member may extend substantially vertically.

A slope portion may extend downwardly from the support. A pair of slope portions may extend downwardly from the support. The, or each, slope portion may engage the release portion. The push member may be movable from a non-actuating position to an actuating position.

The actuating element may be slidable relative to the housing between the actuating and non-actuating positions. The, or each, slope portion may have a lower sloping edge to engage the release portion. The, or each, slope portion may slide across the release portion pressing on the carriage into a position in which the, or each, clamp member is disengaged from the elongate suspension member.

A spring may extend between the housing and the push member. The spring may extend between the socket and the push member. The spring may urge the actuating element away from the actuating position to the non-actuating position.

The support may defines a slot extending along the direction of movement of the actuating element. The slot may define an open end facing the elongate suspension member. When the actuating element is pressed so that it moves to the actuating position, the elongate suspension member may be received in the slot.

The fastening arrangements may include lock members. The lock members may be received in an aperture in the support member. The lock members may be provided on opposite sides of the housing. The lock members may comprise snap fit clips. The aperture may be defined in a side wall of the support member.

Embodiments of the invention will now be described by way of example only, with reference to the accompanying drawings, in which:

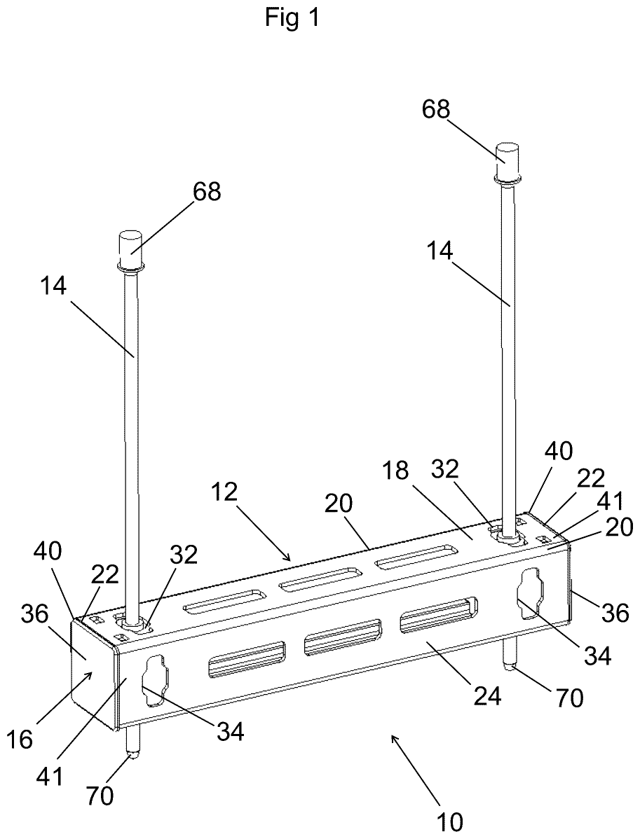

FIG. 1 is a perspective view from above of a first suspension assembly;

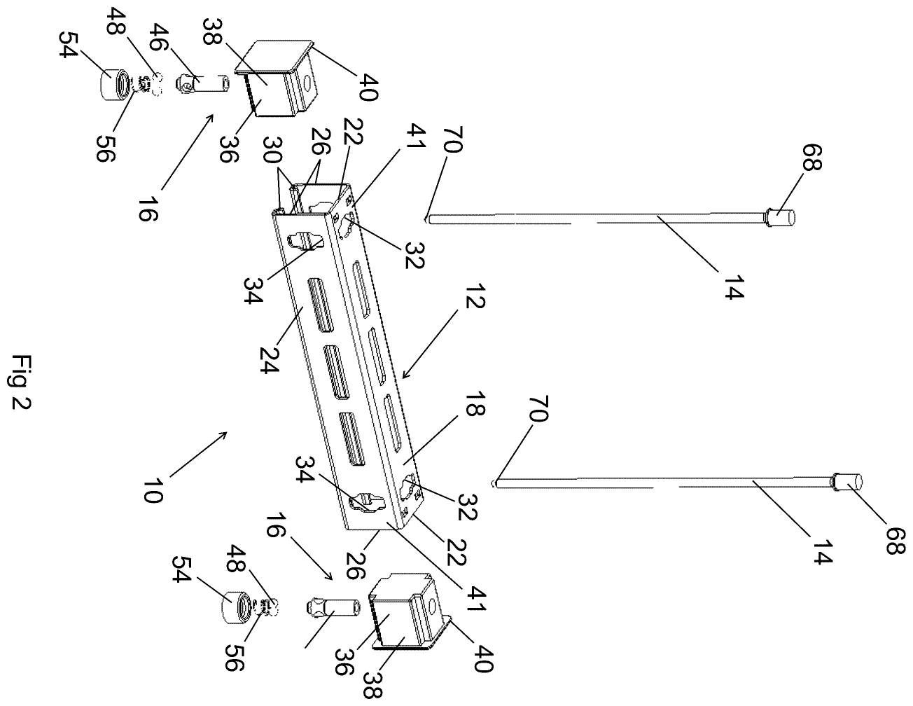

FIG. 2 is an exploded view of the first suspension assembly;

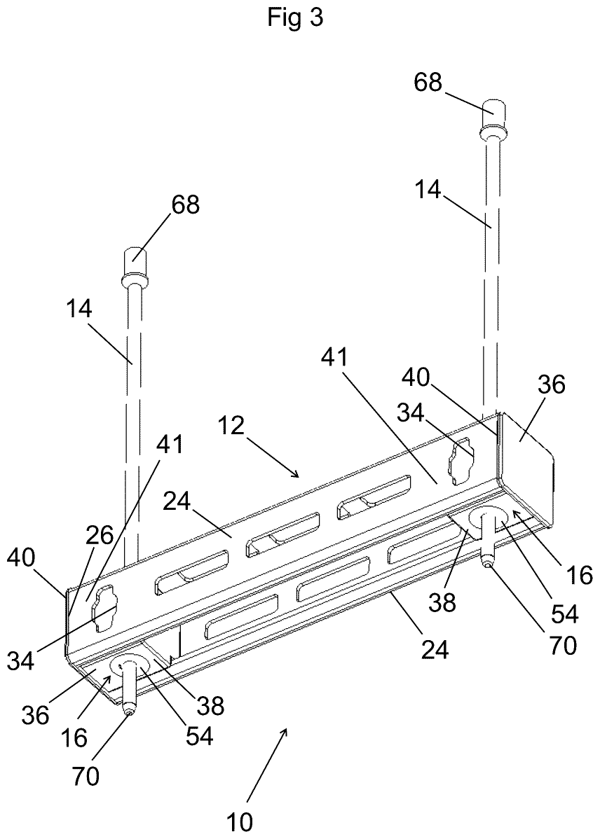

FIG. 3 is a perspective view from below of the first suspension assembly;

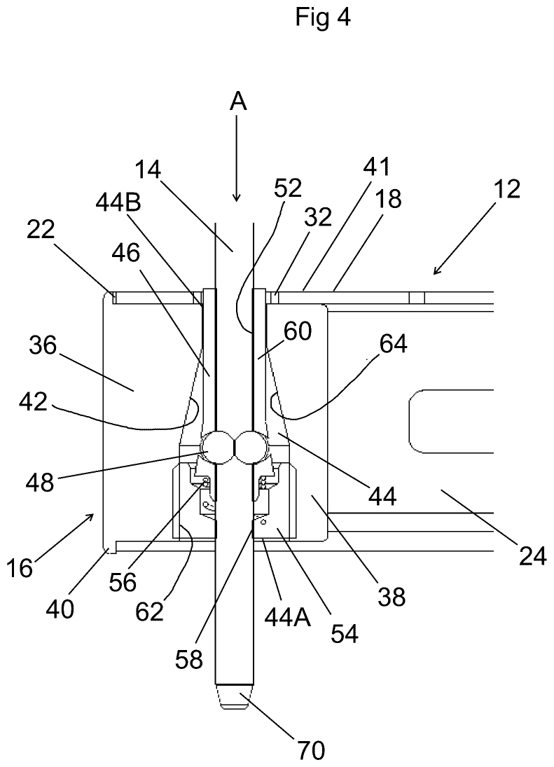

FIG. 4 is a sectional view of one end region of the first suspension assembly, showing a fastening arrangement;

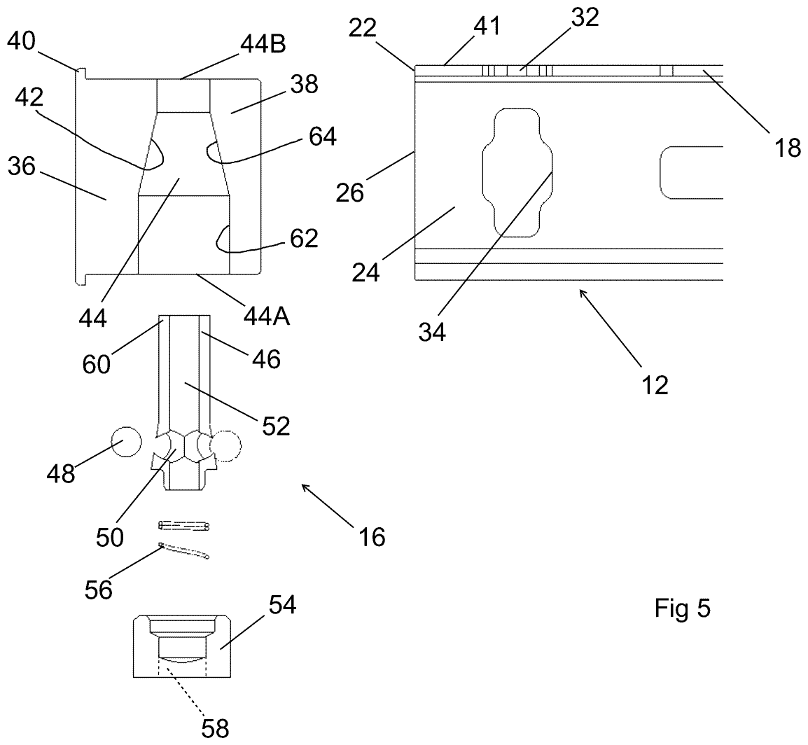

FIG. 5 is an exploded part sectional view of the end region shown in FIG. 4, showing the fastening arrangement;

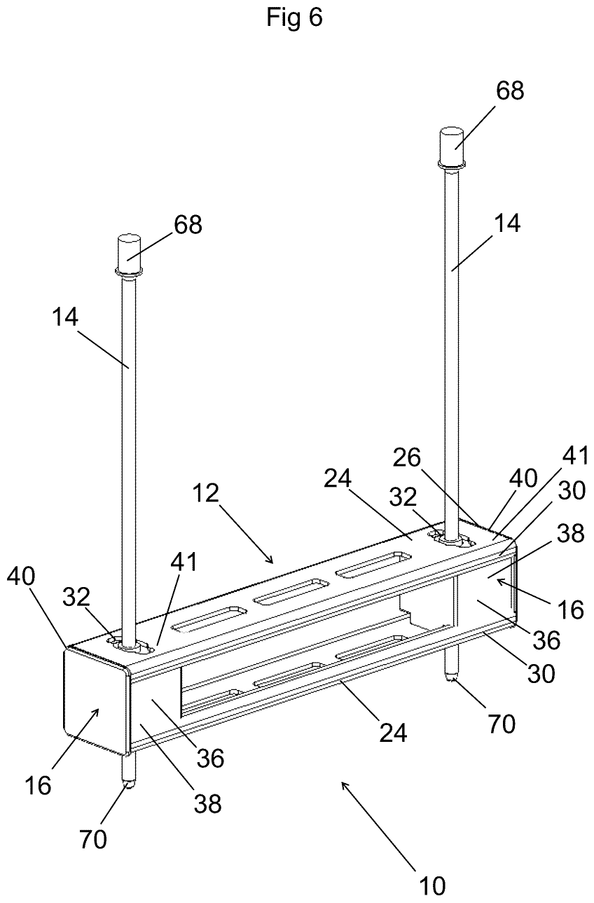

FIG. 6 is a perspective view similar to FIG. 1, but with the support member in another orientation;

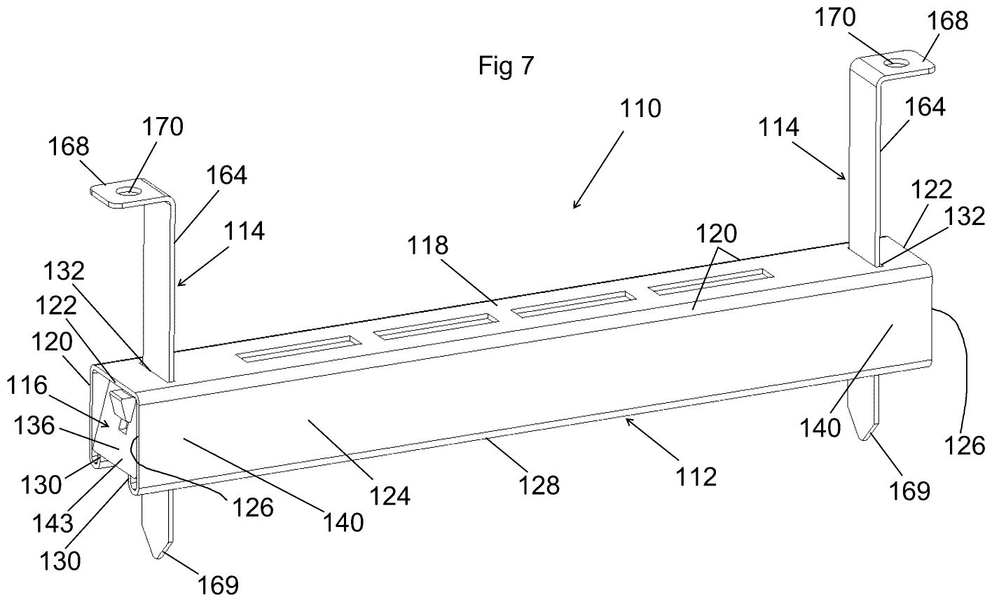

FIG. 7 is a perspective view from above of a second suspension assembly;

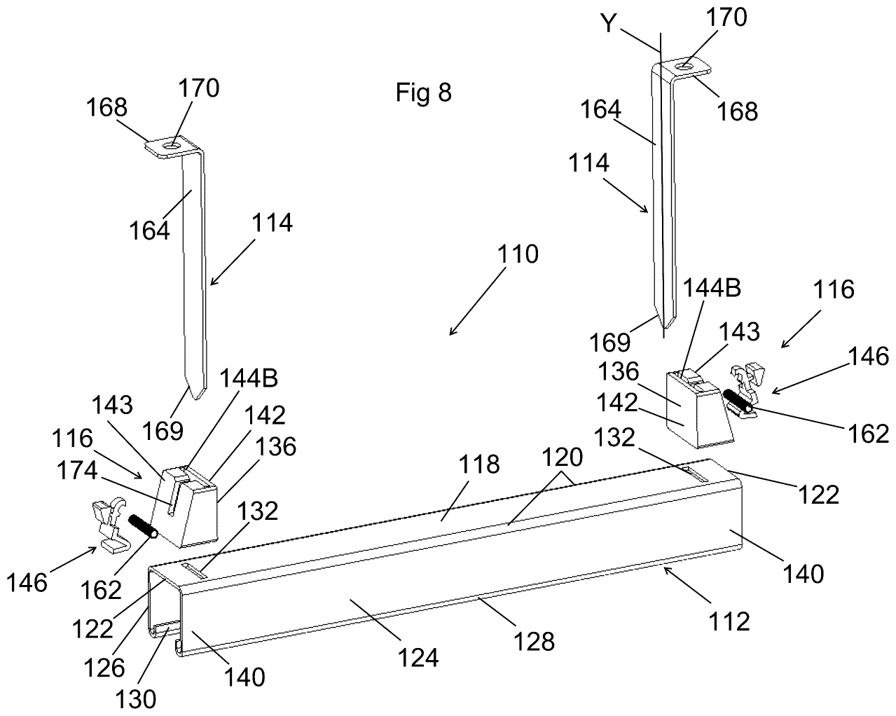

FIG. 8 is an exploded view of the second suspension assembly;

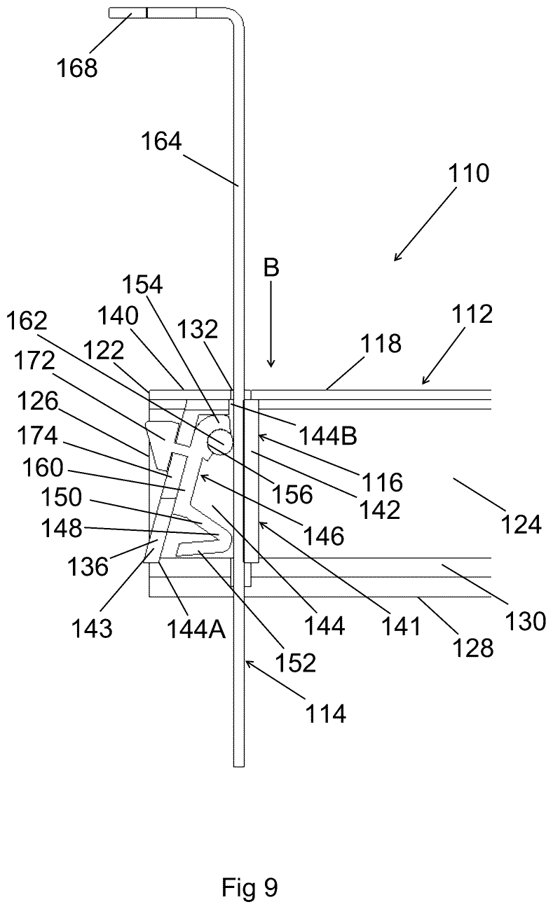

FIG. 9 is a sectional side view of one end region of the second suspension assembly showing a fastening arrangement;

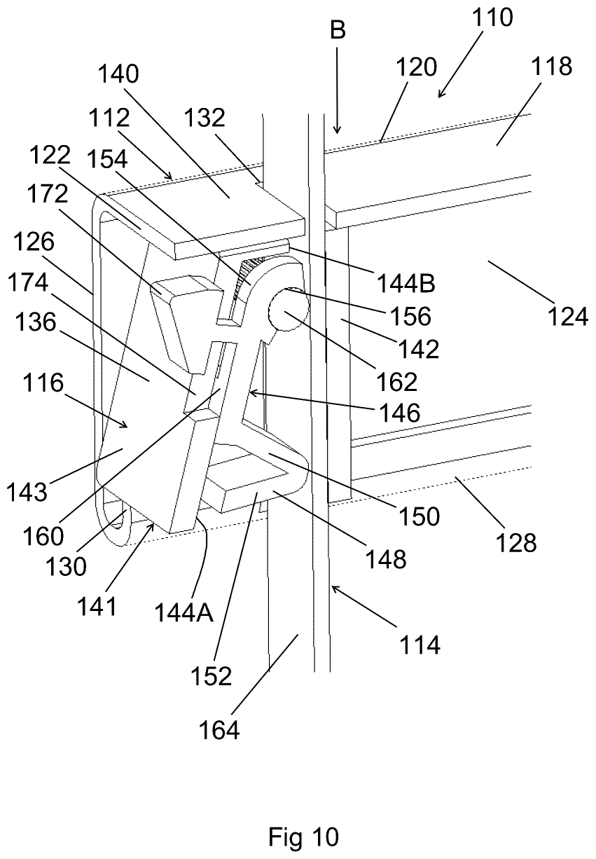

FIG. 10 is a perspective sectional view of the end region shown in FIG. 9, showing the fastening arrangement;

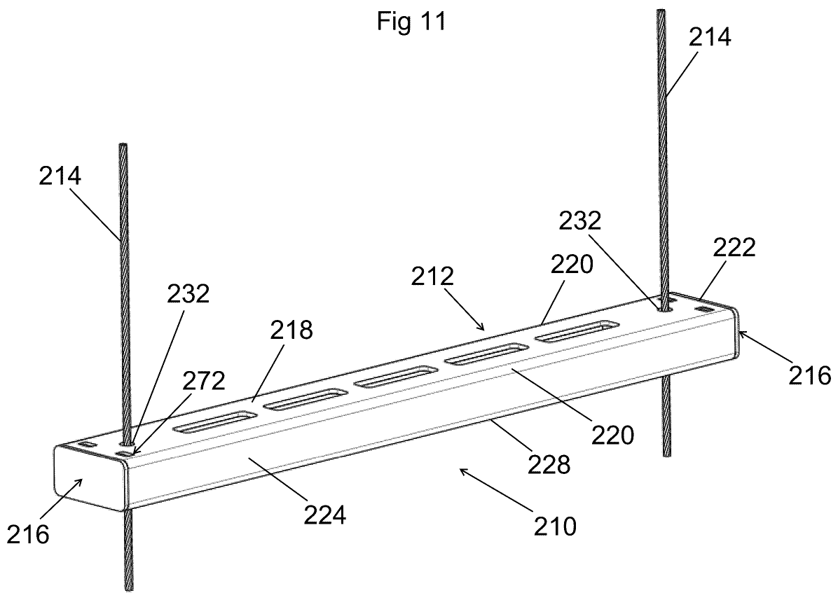

FIG. 11 is a perspective view from above of a third suspension assembly;

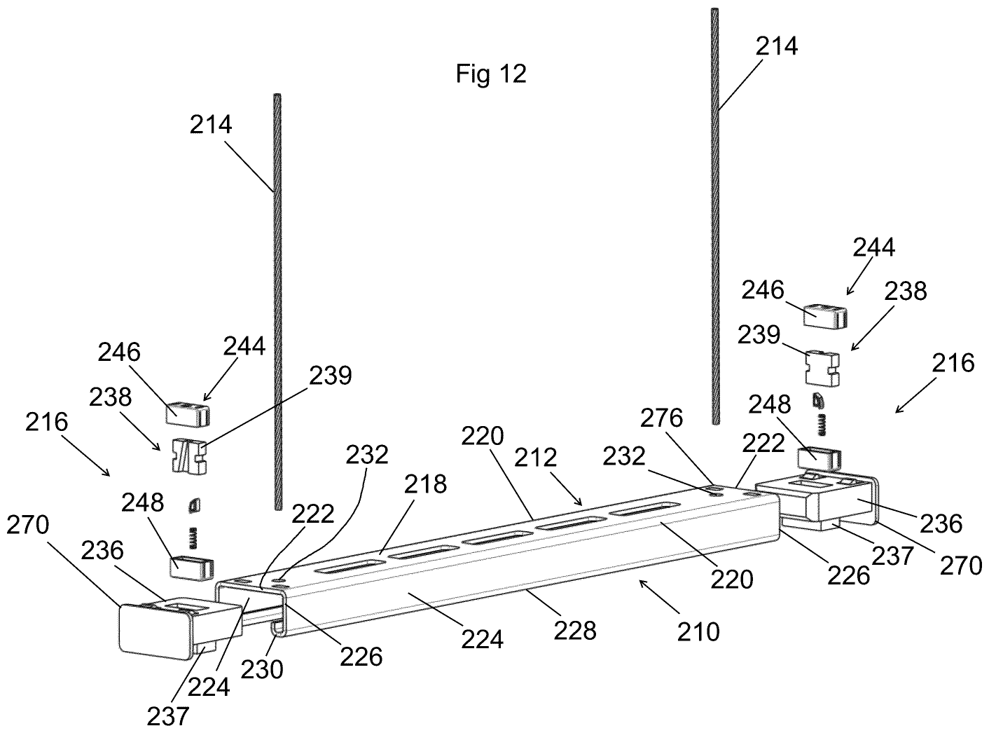

FIG. 12 is an exploded view of the third suspension assembly;

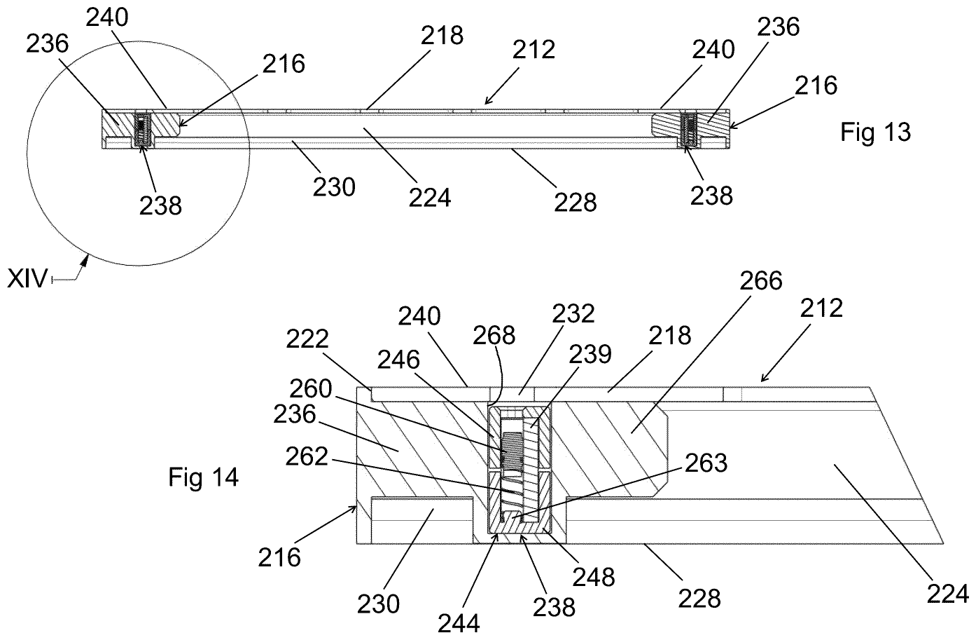

FIG. 13 is a sectional side view of connecting apparatus forming part of the third suspension assembly;

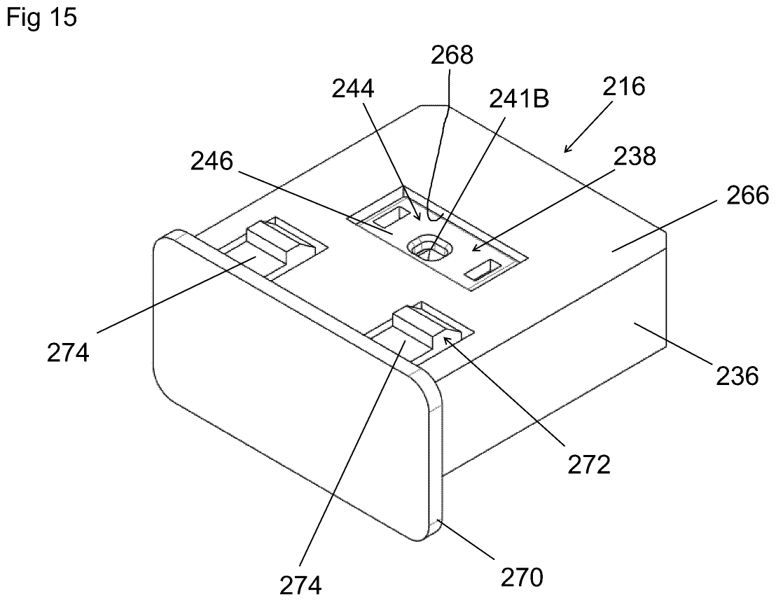

FIG. 14 is a close up view of the region marked XIV in FIG. 13;

FIG. 15 is a perspective view of a fastening arrangement forming part of the third suspension assembly;

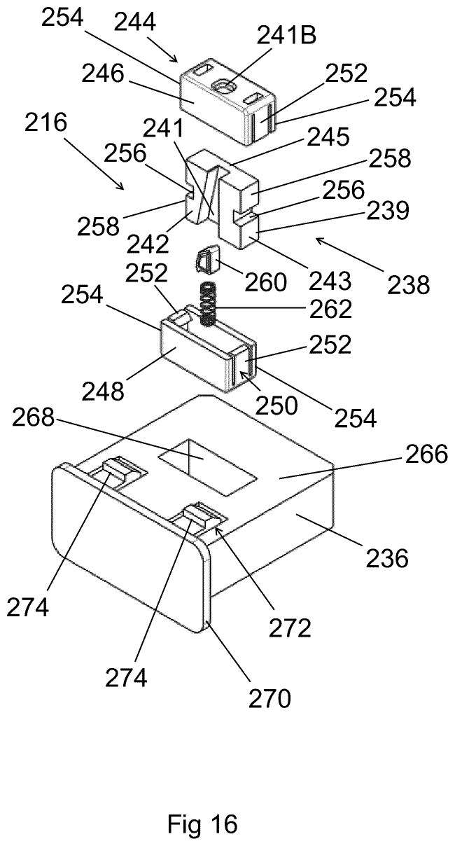

FIG. 16 is an exploded view of the fastening arrangement shown in FIG. 15;

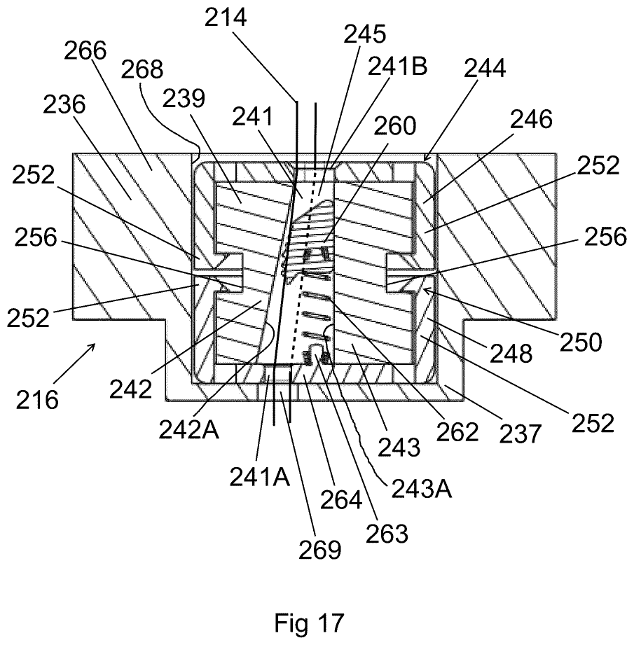

FIG. 17 is a sectional side view of the fastening arrangement shown in FIG. 15;

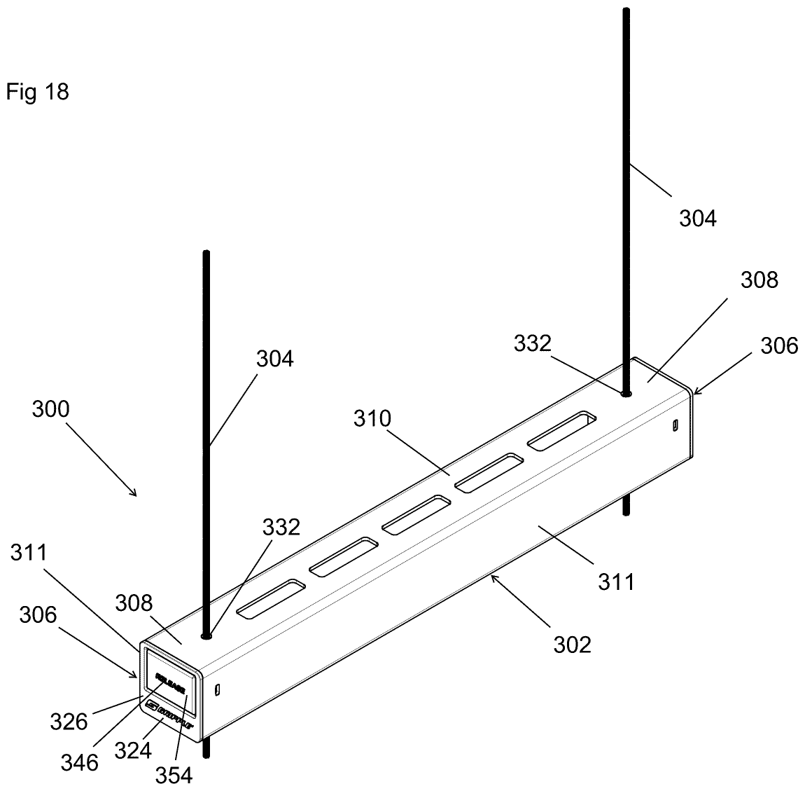

FIG. 18 is a perspective view from above of a fourth suspension assembly;

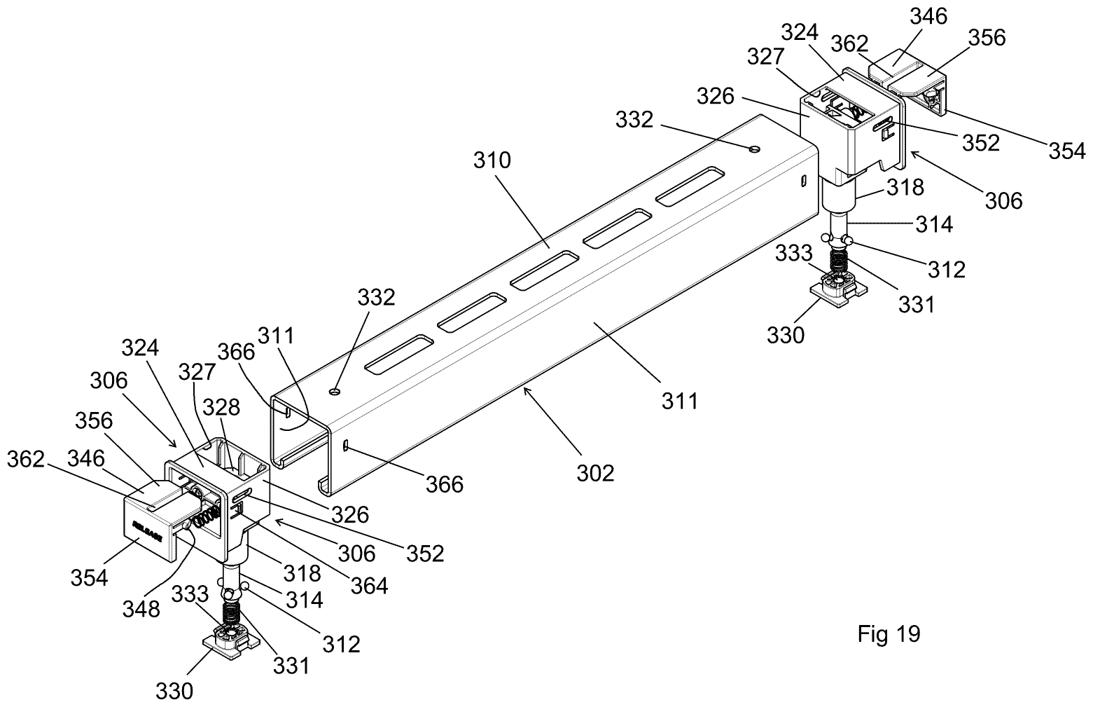

FIG. 19 is an exploded view of the fourth suspension assembly;

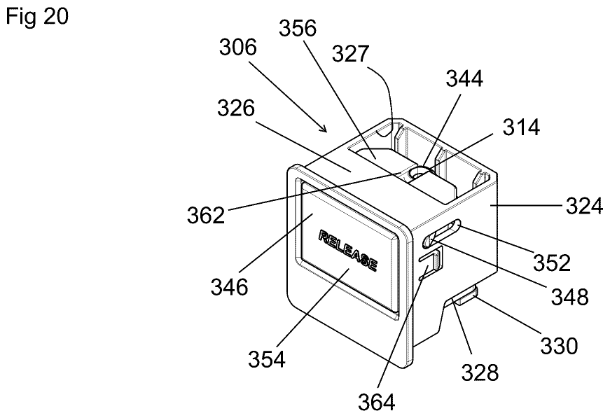

FIG. 20 is a perspective view of a fastening arrangement forming part of the fourth suspension assembly;

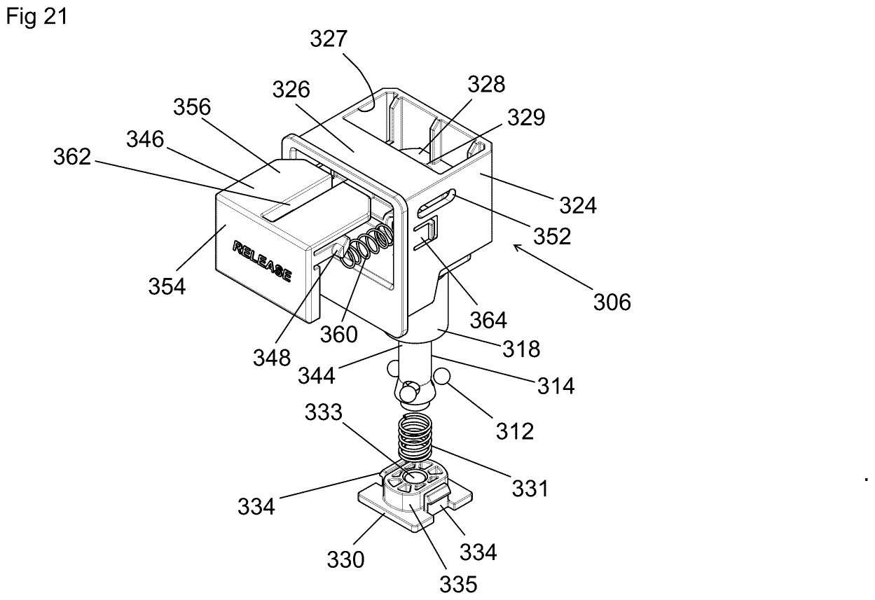

FIG. 21 is an exploded perspective view of the fastening arrangement shown in FIG. 20;

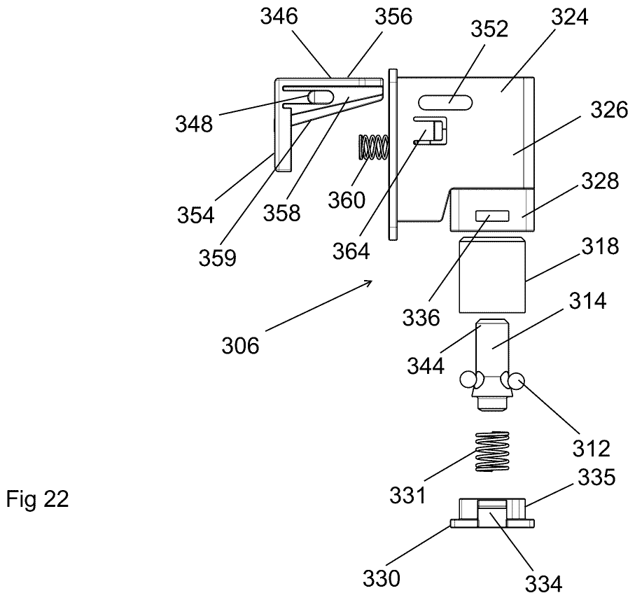

FIG. 22 is an exploded side view of the fastening arrangement shown in FIG. 20; and

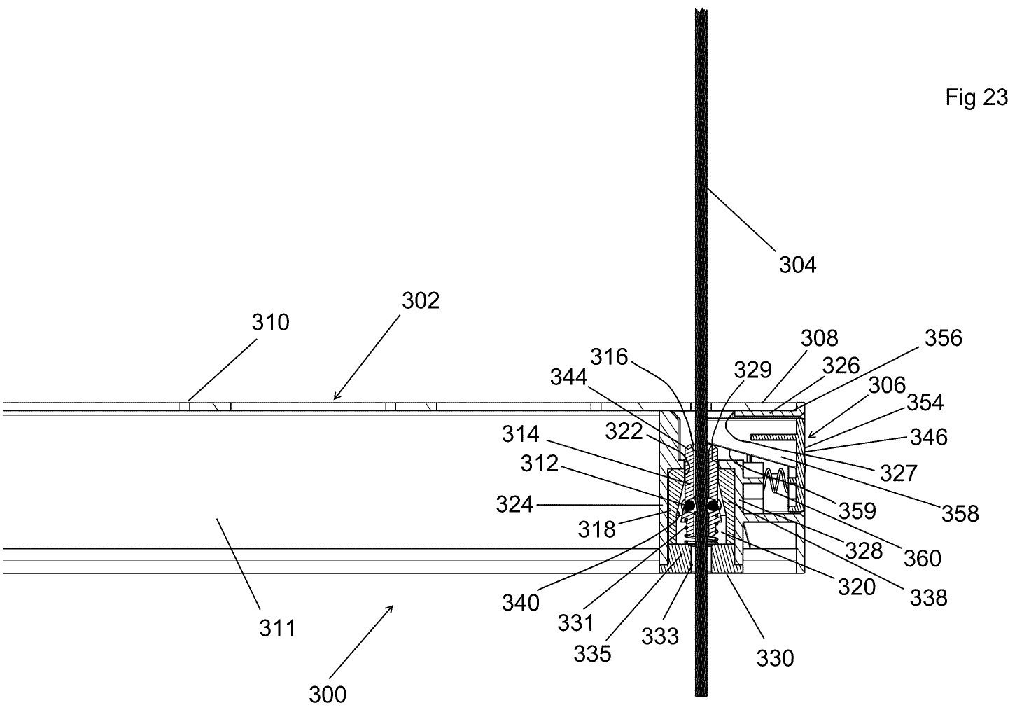

FIG. 23 is a sectional side view of one end region of the fourth suspension assembly.

FIGS. 1 to 6 of the drawings show a first embodiment of a suspension assembly comprising a support member 12, two elongate suspension members 14, and two fastening arrangements 16. Each elongate suspension member 14 is fastened to the support member 12 by a respective one of the fastening arrangements 16. The combination of the support member 12 with one or more of the fastening arrangements 16 constitutes a connecting apparatus.

The support member 12 comprises an elongate planar central support portion 18 having opposite side edges 20 and opposite ends 22. The support member 12 further includes two side support portions 24, each side support portion 24 having opposite ends 26.

The elongate planar side support portions 24 extend from the central support portion 18. Each side support portion 24 is attached to a respective one of the side edges 20 of the central support portion 18. Both side support portions 24 extend in the same direction from the side edges 20 of the central support portion 18, thereby providing the support member 12 with a generally U shaped end profile.

Each of the side support portions 24 has a free edge 28 spaced from the side edge 20 of the central support portion 18. Each free edge 28 is provided with an inwardly extending return formation 30 (see FIG. 2) running the length of the free edge 28. The return formations 30 hold the fastening arrangements 16 in the support members 12, as discussed below.

The central support portion 18 defines two apertures 32 for receiving the elongate suspension members 14 therethrough in one orientation of the support member 12 shown in FIG. 1. A respective one of the apertures 32 is defined adjacent each end 22 of the central support portion 18.

Each side support portion 24 also defines two apertures 34, each aperture 34 being defined by the side support portion adjacent respective opposite ends 26 of the side support portions 24. The apertures 34 in the side support portions 24 receive the elongate suspension members 14 therethrough in another orientation of the support member 12 shown in FIG. 6, and explained in more detail below.

One of the fastening arrangements 16 is shown in FIGS. 4 and 5. The other fastening arrangement 16 is the same as shown in those Figures.

Each fastening arrangement 16 has a body 36 in the form of a housing, thereby providing a cartridge. The body 36 comprises a main part 38 and a flange 40 extending around the main part 38. The body 36 is received in one end region 41 of the support member 12. When so received, the main part 38 rests on the return formations 30, and the flange 40 engages the ends 22, 26 of the central and side support portions 18, 24, thereby mounting the fastening arrangement 16 in the end region 41 of the support member 12.

Referring to FIGS. 4 and 5, the main part 38 has an internal wall arrangement 42 defining a passage 44. Opposite aligned first and second openings 44A, 44B in the main part 38 provide communication between the passage 44 and the region outside the body 36. The first and second openings 44A, 44B allow the elongate suspension member 14 to be received through the passage 44.

The fastening arrangement 16 includes a carriage 46 disposed in the passage 44 in the body 36, and three clamp members 48 carried by the carriage 46 in recesses 50. The clamp members 48 clamp the elongate suspension member 14, thereby securing the elongate suspension member 14 to the fastening arrangement 16.

In the suspension assembly 10 shown in the drawings, the clamp members 48 are in the form of balls. Alternatively, they could be rollers or wedges.

The carriage 46 defines a through bore 52. When the elongate suspension member 14 is received through the passage 44, the elongate suspension member 14 extends through the bore 52.

The fastening arrangement 16 also includes a reaction member 54, and an urging member in the form of a spring 56. The reaction member 54 is provided in the passage 44 across the first opening 44A. The reaction member 54 defines a hole 58 through which the elongate suspension member 14 extends into the passage 44. The spring 56 is provided in the passage 44 between the reaction member 54 and the carriage 46, and urges the carriage 46 towards the second opening 44B.

The carriage 46 has a release portion 60 for releasing the clamp members 48 from clamping the elongate suspension member 14. The release portion 60 comprises a cylindrical portion of the carriage 46. The release portion 60 is in the form of a button extending through the second opening 44B in the body 36 when the elongate suspension member 14 is clamped by the clamp members 48. To release the clamp members 48 from clamping the elongate suspension member 14, the user presses the release portion 60 towards the body 36, thereby moving the carriage 46 in a direction opposite to the clamping direction.

The wall arrangement 42 has a cylindrical holding region 62 for holding the reaction member 54. The holding region 62 is arranged adjacent the first opening 44A. The reaction member 54 is held within the passage 44 at the holding region 62.

The wall arrangement 42 has a clamping region 64 that converges from the holding region 62 towards the second opening 44B. The carriage 46 is held within the passage 44 at the clamping region 64.

Each elongate suspension member 14 comprises a rod, and has a fastening arrangement 68 at one end. In the drawings, the fastening arrangement 68 is shown as being in the form of threads, but it could be another type of fastening arrangement. The fastening arrangement 68 fastens the elongate suspension member 14 to an upper member, such as a ceiling or a roof member.

Alternatively, each elongate suspension member 14 is in the form of a flexible elongate suspension member, such as a wire, wire rope, strand, cable or the like.

The opposite end 70 of the elongate suspension member 14 tapers inwardly, thereby facilitating the insertion of the elongate suspension member 14 into the passage 44.

In use, the body 36 is received within an end region 41 of the support member 12. In one orientation, shown in FIGS. 1 to 3, the support member 12 is oriented so that the central support portion 18 faces upwardly. In another orientation, shown in FIG. 6, the central support portion 18 faces to the side, and one of the side members faces upwardly.

In the orientation shown in FIGS. 1 to 3, the bodies 36 are inserted into the end regions 41 of the support member 12 so that each second opening 44B is aligned with the aperture 32 in the central support portion 18 at the respective end region 41. The first and second openings 44A, 44B of each body 36 are aligned with each other, which means that the first opening 44A is also aligned with the respective aperture 32 in the central support portion 18.

Two elongate suspension members 14 are attached to the ceiling or roof support in alignment with the apertures 32 in the central support portion 18 of the support member 12. The support member 12 is presented to the elongate suspension members 14 so that the tapering end 70 of the elongate suspension member 14 is inserted in the direction of the arrow A in FIG. 4 through the respective aperture 32 in the central support portion 18. The elongate suspension member 14 is received via the second opening 44B in the body 36 into the passage 44.

The tapering end 70 of the elongate suspension member 14 engages the clamp members 48 held by the carriage 46, and pushes the carriage 46 towards the first opening 44A, from a narrow region of the converging wall arrangement 42 to a wider region of the converging wall arrangement 42. As a result, the clamp members 48 are moved outwardly by the tapering end 70 to allow the elongate suspension member 14 to pass through the bore 52 in the carriage 46 so that the elongate suspension member 14 extends out of the first opening 44A in the body 36, as shown in FIGS. 1 and 3.

The spring 56 urges the carriage 46 towards the second opening 44B, and the converging wall arrangement 42 urges the clamp members 48 into engagement with the elongate suspension member 14. To effect tight engagement of the clamp members 48 with the elongate suspension member 14, the elongate suspension member 14 can be pulled in the direction opposite to the direction indicated by the arrow A. This pulls the carriage 46 in the same direction, so that the converging wall arrangement 42 urges the clamp members 48 into tight engagement with the elongate suspension member 14.

In this position of the carriage 46, the release portion 60 projects from the central member, and can be pressed by the user to move the carriage 46 towards the first opening 44A in the body 36. This releases the clamp members 48 from the elongate suspension member 14 to allow the support member 12 to be moved along the elongate suspension member 14, thereby positioning the support member 12 as desired along the elongate suspension member 14.

The above process can be carried out substantially at the same time for the fastening arrangements 16 at both opposite end regions 41 of the support member 12.

In the orientation of the support member 12 shown in FIG. 6, each body 36 is inserted into the respective end region 41 of the support member 12 so that each second opening 44B is aligned with the aperture 34 in the upwardly facing side support portion 24 adjacent the respective end. The first opening 44A of each body 36 are thus aligned with the apertures 34 in the other side support portion 24. As a result, when the support member 12 is positioned on the elongate suspension members 14 as shown in FIG. 6, the elongate suspension members 14 extend through both side support portions 24.

There is thus described a suspension assembly 10 that allows a support member 12 to be fastened to elongate suspension members 14 fastened to a ceiling or roof support. The suspension assembly 10 has a fastening arrangement 16 that allows quick and easy securing of the support member 12 to the elongate suspension members 14.

FIGS. 7 to 10 of the drawings show a second embodiment of the suspension assembly, generally designated 110. The suspension assembly 110 comprises a support member 112, two elongate suspension members 114, and two fastening arrangements 116 in the form of clamping arrangements. Each elongate suspension member 114 is in the form of a strap.

Each elongate suspension member 114 is fastened to the support member 112 by a respective one of the fastening arrangements 116. The combination of the support member 112 with one or more of the fastening arrangements 116 constitutes a connecting apparatus.

The support member 112 comprises an elongate planar central support portion 118 having opposite side edges 120 and opposite ends 122. The support member 112 further includes two side support portions 124, each side support portion 124 having opposite ends 126.

The elongate planar side support portions 124 extend from the central support portion 118. Each side support portion 124 is attached to a respective one of the side edges 120 of the central support portion 118. Both side support portions 124 extend in the same direction from the side edges 120 of the central support portion 118, thereby providing the support member 112 with a generally U shaped end profile.

Each of the side support portions 124 has a free edge 128 spaced from the side edge 120 of the central support portion 118. Each free edge 128 is provided with an inwardly extending return portion 130 (see FIGS. 7 and 8) along the length of the free edge 128. The return portions 130 mount the fastening arrangements 116 in the support members 112, as discussed below.

The central support portion 118 defines two apertures 132 for receiving the elongate suspension members 114 therethrough. A respective one of the apertures 132 is defined adjacent each end 122 of the central support portion 118.

One of the fastening arrangements 116 is shown in FIGS. 9 and 10. The other fastening arrangement 116 is the same.

Each fastening arrangement 116 has a body 136 in the form of a housing, thereby providing a cartridge. The body 136 is received in one end region 140 of the support member 112. When so received, the body 136 rests on the return portions 130, thereby mounting the fastening arrangement 116 in the end region 140 of the support member 112.

Referring to FIGS. 9 and 10, the body 136 comprises a wall arrangement 141 having opposite first and second clamping wall portions 142, 143. The first and second clamping wall portions 142, 143 define a passage 144 therebetween.

Opposite aligned first and second openings 144A, 144B defined by the body 136 provide communication between the passage 144 and the region outside the body 136.

The first opening 144A is arranged adjacent the return portions 130. The second opening 144B is arranged adjacent the central support portion 118. The first and second openings 144A, 144B are aligned with one of the apertures 132 in the central support portion 118 to allow the elongate suspension member 114 to be received through the passage 144. The first and second clamping wall portions 142, 143 extend at an acute angle to each other, and converge towards each other from the first opening 144A to the second opening 144B.

Referring to FIGS. 9 and 10, the fastening arrangement 116 includes a carriage 146 disposed in the passage 144. A resilient urging member in the form of a spring 148 extends from the carriage 146. The resilient spring 148 comprises a resilient portion 150 and a foot portion 152. The resilient portion 150 extends from the carriage 146 to the foot portion 152. It will be appreciated that the resilience of the resilient portion 150 is provided mainly by the regions connecting the resilient portion to the carriage 146 and connecting the resilient portion 150 to the foot portion 152.

The foot portion 152 extends from the resilient portion 150 along the return portions 130 in engagement therewith. The return portions 130 act as a reaction formation to apply a reaction force to the spring 148 to allow the spring 148 to urge the carriage 146 towards the second opening 144B.

The carriage 146 comprises a C-shaped holding member 154 defining a recess 156. The carriage 146 further includes an attaching portion 160 to attach the holding member 150 to the spring 148.

The fastening arrangement 116 further includes a clamp member 162 held by the C-shaped holding member 154. As explained in more detail below, the clamp member 162 clamps the elongate suspension member 114, thereby securing the elongate suspension member 114 to the fastening arrangement 116.

Each elongate suspension member 114 comprises an elongate substantially flat suspending portion 164, and a substantially flat fastening portion 168 at one end of the suspending portion 164. The fastening portion 168 extends transverse to the suspending portion 164. The opposite end 169 of the elongate suspension member 114 tapers inwardly, thereby facilitating the insertion of the elongate suspension member 114 into the passage 144.

The fastening portion 168 defines a fastening aperture 170 through which a fastener, such as a screw or a nail, can be inserted to fasten the elongate suspension member 114 to an upper member, such as a ceiling or a roof member.

The suspending portion 164 has a longitudinal main axis Y. The first clamping wall portion 142 extends substantially parallel to the main axis Y of the suspending portion. The second clamping wall portion 143 converges towards the suspending portion 164 of the elongate suspension member 114.

The carriage 146 has a release portion 172 for releasing the clamp member 162 from clamping the elongate suspension member 114. The release portion 172 is in the form of a slidable button. The release portion 172 projects from the attaching portion 160 of the carriage 146.

The second clamping wall portion 143 defines a slot 174 through which the release portion 172 extends. To release the clamp member 162 from clamping the elongate suspension member 114, the user presses the release portion 172 downwards along the slot 174, thereby moving the carriage 146 in a direction opposite to the clamping direction.

In use, the body 136 is received within an end region 140 of the support member 112. As shown in FIGS. 7 and 8, the support member 112 is oriented so that the central support portion 118 faces upwardly.

The bodies 136 are inserted into both end regions 140 of the support member 112 so that each second opening 144B is aligned with the aperture 132 in the central support portion 118 at the respective end region 140. The first and second openings 144A, 144B of each body 136 are aligned with each other, which means that the first opening 144A is also aligned with the respective aperture 132 in the central support portion 118.

Two elongate suspension members 114 are fastened to the ceiling or roof support in alignment with the apertures 132 in the central support portion 118 of the support member 112. The support member 112 is presented to the elongate suspension members 114 so that the tapering end 169 of the elongate suspension member 114 is inserted in the direction of the arrow B in FIGS. 9 and 10 through the respective aperture 132 in the central support portion 118. The elongate suspension member 114 is received via the second opening 144B into the passage 144.

The tapering end 169 of the elongate suspension member 114 engages the clamp member 162 held by the carriage 146, and pushes the carriage 146 towards the first opening 144A, from a narrow region between the converging first and second clamping wall portions 142, 143 to a wider region between the converging first and second clamping wall portions 142, 143.

As a result, the holding member 154 and the clamp member 162 are moved away from the first clamping wall portion 142 by the tapering end 170 of the elongate suspension member 114 to allow the elongate suspension member 114 to pass through the passage in the body 136, so that the elongate suspension member 114 extends out of the first opening 144A of the body 136, as shown in FIGS. 7, 9 and 10.

The spring 148 urges the carriage 146 towards the second opening 144B, and the converging of the second clamping wall portion 143 towards the first clamping wall portion 142 urges the carriage towards the elongate suspension member 114. This urges the clamp member 162 into engagement with the elongate suspension member 114.

To effect tight engagement of the clamp member 162 with the elongate suspension member 114, the elongate suspension member 114 can be pulled in the direction opposite to the direction indicated by the arrow B. This pulls the carriage 146 in the same direction, so that the first clamping wall portion 142 converging towards the second clamping wall portion 143 urges the clamp member 162 into tight engagement with the elongate suspension member 114.

The release portion 162 projects through the slot 174, and can be pressed by the user to move the carriage 146 towards the first opening 144A in the body 136. This releases the clamp member 162 from the elongate suspension member 114 to allow the support member 112 to be moved along the elongate suspension member 114, thereby positioning the support member 112 as desired along the elongate suspension member 114.

The above process can be carried out substantially at the same time for the fastening arrangements 116 at both opposite end regions 140 of the support member 112.

There is thus described suspension assemblies 10, 110 that allows a support member 12, 112 to be fastened to elongate suspension members 14, 114 fastened to a ceiling or roof support. Each suspension assembly 10, 110 has a fastening arrangement 16, 116 that allows quick and easy securing of the support member 12, 112 to the elongate suspension members 14, 114.

The embodiments of the suspension assembly 110 described above provides users with a quick and easy to install prefabricated assembly for the installation of electrical, HVAC or piping systems, with infinite adjustment along the elongate suspension member 114. The above embodiments avoid the need to fasten nuts and washers to a threaded rod. The elongate suspension members 114 can also be folded underneath the support member 112 avoiding the need to cut them.

The suspension assembly has a release portion so that the fastening arrangement can be easily released, thereby allowing the support member 12, 112 to be easily adjusted along the elongate suspension members 14, 114.

The fastening arrangement 16, 116 can be pre-assembled within the support member 12, 112 to facilitate installation.

Various modifications can be made without departing from the scope of the invention. For example, the side support portions 124 may define the apertures 132 to allow the support member 112 to be used in an orientation in which the side support portions 124 are arranged uppermost and lowermost. In this orientation, the elongate suspension members 114 extend through the side support portions 124.

In a further modification, each of the suspension assemblies 10, 110 may comprise a single elongate suspension member 14, 114. With such a modification, the support members 12, 112 are cantilevered from, or supported centrally by, the elongate suspension member 14, 114.

FIGS. 11 to 17 of the drawings show another modification, comprising a second embodiment of the suspension assembly, generally designated 210. The suspension assembly 210 comprises a support member 212, two elongate suspension members 214, and two fastening arrangements 216 in the form of clamping arrangements. Each elongate suspension member 214 is in the form of a flexible elongate suspension member, such as a wire, wire rope, strand, cable or the like.

Each elongate suspension member 214 is fastened to the support member 212 by a respective one of the fastening arrangements 216. The combination of the support member 212 with one or more of the fastening arrangements 216 constitutes a connecting apparatus.

The support member 212 comprises an elongate planar central support portion 218 having opposite side edges 220 and opposite ends 222. The support member 212 further includes two elongate planar side support portions 224, each side support portion 224 having opposite ends 226.

The side support portions 224 extend from the central support portion 218. Each side support portion 224 is attached to a respective one of the side edges 220 of the central support portion 218. Both side support portions 224 extend in the same direction from the side edges 220 of the central support portion 218, thereby providing the support member 212 with a generally U shaped end profile.

Each of the side support portions 224 has a free edge 228 spaced from the side edge 220 of the central support portion 218. Each free edge 228 is provided with an inwardly extending return portion 230 (see FIG. 12) along the length of the free edge 228. The return portions 230 mount the fastening arrangements 216 in the support members 212, as discussed below.

The central support portion 218 defines two apertures 232 for receiving the elongate suspension members 214 therethrough. The support member 212 has opposite end regions 240 adjacent the opposite ends 222. A respective one of the apertures 232 is defined adjacent each end 222 in each end region 240 of the central support portion 218.

One of the fastening arrangements 216 is shown in FIGS. 14 to 17. The other fastening arrangement 216 is the same.

Each fastening arrangement 216 has a body 236 received in one end region 240 of the support member 212. When so received, the body 236 rests on the return portions 230, thereby mounting the fastening arrangement 216 in the end region 240 of the support member 212.

The body 236 has a downwardly extending compartment 237 for receiving a region of the clamping component 238. When the body 236 rests on the return portions 230, the compartment 237 is disposed between the return portions 230.

Referring to FIGS. 16 and 17, the fastening arrangement 216 comprises a clamping component 238 for clamping the elongate suspension member 214. The clamping component 238 comprises a wall arrangement 239 having opposite first and second clamping wall portions 242, 243, and a connecting wall portion 245 extending between the first and second clamping wall portions 242, 243. The clamping component 238 defines a passage 241 between the opposite first and second clamping wall portions 242, 243.

The clamping component 238 further includes a housing 244, thereby providing a cartridge. The housing 244 houses the wall arrangement 239. The housing 244 comprises first and second housing portions 246, 248. The first housing portion 246 receives a first region 238A of the wall arrangement. The second housing portion 248 receives a second region 238B of the clamping component 238.

The first and second housing portions 246, 248 meet at a central region of the wall arrangement 239, and are affixed to the clamping component 238 by cooperating affixing formations 250. The affixing formations 250 comprise snap fit formations in the form of resilient hook members 252 on opposite edges 254 of each of the first and second housing portions 246, 248. The resilient hook members 252 are received by depressions 256 defined by opposite edges 258 of the wall arrangement 239.

The housing 244 defines opposite first and second openings 241A, 241B. The first and second openings 241A, 241B provide communication between the passage 241 and the region outside the body 236.

The first housing portion 246 defines the first opening 241A. The second housing portion 248 defines the second opening 241B. Each first opening 241A is offset from the respective second opening 241B.

The first clamping wall portion 242 has a first inner surface 242A. The second clamping wall portion 243 has a second inner surface 243A. The second inner surface 243A extends perpendicular to the central support portion 218. The first inner surface 242A extends from the first opening 241A to the second opening 241B, and thus slopes relative to the central support portion 218.

Each of the second openings 241A, 241B is aligned with a respective one of the apertures 232 in the central support portion 218 of each of the support arrangements 216 to allow the elongate suspension member 214 to be received through the passage 241. The first and second clamping wall portions 242, 243 extend at an acute angle to each other, and converge towards each other towards the second opening 241B.

In the embodiment shown, the second clamping wall portion 243 extends perpendicular to the central support portion 218.

The clamping component 238 includes a clamp member 260 disposed in the passage 241. The clamp member 260 is in the form of a wedge, but it could be a ball or a roller. The clamp member 260 clamps the elongate suspension member 214 against the first surface 242A of the first wall portion 242.

A resilient urging member in the form of a spring 262 is provided to urge the clamp member 260 into engagement with the elongate suspension member 214, thereby securing the elongate suspension member 214 to the fastening arrangement 216. The spring 262 is arranged between a reaction member 264 and the clamp member 260. The second housing portion 248 includes the reaction member 264.

The reaction member 264 applies a reaction force to the spring 262 to enable the spring 262 to effect the aforesaid urging of the clamp member 260. A lug 263 is provided on the reaction member 264 to locate the spring 262 thereon. The spring 262 receives the lug 263 to locate the spring 262 on the reaction member 264.

The reaction member 264 is in the form of a wall of the first housing portion 246, and is arranged adjacent the first opening 241A defined by the first housing portion 246.

The body 236 includes a main part 266 defining a recess 268. When the clamping component 238 is housed in the housing 244, the clamping component 238 can be received in the recess 268.

The receptacle 266 defines an outer opening 269 in the recess 268. The region of the receptacle 266 defining the outer opening 269 is contiguous with the region of the first housing portion 246 defining the first opening 241A. The outer opening 269 is aligned with the first opening 241A.

The elongate suspension member 214 extends through the outer opening 269 when the elongate suspension member 214 is received through the passage 241 and extends through the first and second openings 241A, 241B.

The body 236 includes a flange portion 270 on the main part 266. When the body 236 is received in the end region 240 of the support member 214, the main part 266 is provided within the end region 240, and the flange 270 engages the respective end 222 of the support member 214.

The body 236 and the support member 214 further include a locking arrangement 272 for locking the body 236 to the support member 214. The locking arrangement 272 comprises a pair of snap-fit members 274 on the main part 266 of the body 236. The locking arrangement 272 further comprises a pair of holes 276 defined in each of the end regions 240 support member 214.

In use, the body 236 is received within an end region 240 of the support member 212. As shown in FIG. 12, the support member 112 is oriented so that the central support portion 218 faces upwardly.

The body 236 of each of the fastening arrangements is inserted into the respective end regions 240 of the support member 212. When so inserted, each second opening 241B is aligned with a respective one of the apertures 232 in the central support portion 218 at the respective end region 240.

The two elongate suspension members 214 are fastened to the ceiling or roof support in alignment with the apertures 232 in the central support portion 118 of the support member 112. The support member 212 is presented to the elongate suspension members 214 so that the elongate suspension members 214 are inserted through the respective aperture 232 in the central support portion 218. Each elongate suspension member 214 is thus received via the second opening 241B into the passage 241.

The lower end of the elongate suspension member 214 engages the clamp member 260, and pushes the clamp member 260 towards the first opening 241A, from a narrow region between the converging first and second clamping wall portions 242, 243 to a wider region between the converging first and second clamping wall portions 242, 243.

As a result, the clamp member 260 is moved away from the first clamping wall portion 242 by the end of the elongate suspension member 214 to allow the elongate suspension member 214 to pass through the passage 241. The path of the elongate suspension member 214 is shown in FIG. 17 in broken lines. The elongate suspension member 214 extends through the second opening, 241B of the housing 244, along the passage 241, and out of the first opening 241A, as shown in FIG. 17.

The spring 262 urges the clamp member 260 towards the second opening 241B, and further into the narrowing gap between the converging first and second clamping wall portions 242, 243.

To effect tight engagement of the clamp member 260 with the elongate suspension member 214, the elongate suspension member 114 can be pulled in the direction indicated by the arrow C in FIG. 17. This pulls the clamp member 260 in the same direction, so that the clamp member 260 and the elongate suspension member 214 are both clamped between the first clamping wall portion 142 and the second clamping wall portion 243.

The above steps can be carried out substantially at the same time for the fastening arrangements 216 at both opposite end regions 240 of the support member 212.

There is thus described suspension assemblies 10, 110, 210 that allow a support member 12, 112, 212 to be fastened to elongate suspension members 14, 114, 214 fastened to a ceiling or roof support. Each suspension assembly 10, 110, 210 has a fastening arrangement 16, 116, 216 that allows quick and easy securing of the support member 12, 112, 212 to the elongate suspension members 14, 114, 214.

The embodiments of the suspension assemblies 10, 110, 210 described above provide users with a quick and easy to install prefabricated assembly for the installation of electrical, HVAC or piping systems, with infinite adjustment along the elongate suspension member 14, 114, 214. The above embodiments avoids the need to fasten nuts and washers to a threaded rod. The elongate suspension members 14, 114, 214 can also be folded underneath the support member 112 avoiding the need to cut them.

Each of the suspension assemblies 10, 110, 210 has a release portion so that the fastening arrangement can be easily released, thereby allowing the support member 12, 112 to be easily adjusted along the elongate suspension members 14, 114.

The fastening arrangement 16, 116, 216 can be pre-assembled within the support member 12, 112, 212 to facilitate installation.

Various modifications can be made without departing from the scope of the invention. For example, the side support portions 124 may define the apertures 132 to allow the support member 112 to be used in an orientation in which the side support portions 124 are arranged uppermost and lowermost. In this orientation, the elongate suspension members 114 extend through the side support portions 124.

In a further modification, each of the suspension assemblies 10, 110, 210 may comprise a single elongate suspension member 14, 114, 214. With such a modification, the support members 12, 112, 212 are cantilevered from, or supported centrally by, the elongate suspension member 14, 114, 214.

In an alternative embodiment, shown in FIGS. 18 to 23, a suspension assembly 300 is shown, comprising a support member 302, two elongate suspension members 304, and two fastening arrangements 306. A respective fastening arrangement 306 is received in each of the end regions 308 of the support member 302. The suspension members 304 are clamped by the fastening arrangements 306. The support member has a central wall 310 and two side walls 311.

The fastening arrangement 306 has three clamp members 312 in the form of balls held by a carriage 314. The carriage 314 defines a through bore 316.

A barrel member 318 defines a space 320 in which the carriage 314 is received. The barrel member 318 defines a hole 322 aligned with the bore 316. The balls 312 are arranged in the carriage 314 in an equispaced array around the bore 316, and held in place by the barrel member 318.

The fastening arrangement 306 further includes a housing 324, thereby providing a cartridge. The housing 324 has an outer part 326 and an inner socket 328. The outer part 326 defines an opening 327 through which the suspension member 304 extends.

Each of the opposite end regions 308 of the central wall 310 of the support member 302 define an aperture 332 through which the suspension member 304 extends.

The carriage 314 and the barrel member 318 are received in the socket 328. The carriage 314 is movably mounted within the space 320. The socket 328 defines an aperture 329 through which the suspension member 304 extends.

A reaction member 330 secures the carriage 314 within the housing 324. The reaction member 330 comprises a platform 335. An urging member in the form of a spring 331 is disposed on the platform 335, and extends between the reaction member 330 and the carriage 314. The reaction member 330 defines an aperture 333 through which the suspension member 304 extends.

The hole 322 in the barrel member 318, the bore 316 (see FIG. 23) through the carriage 314, the opening 327 in the socket 328, the opening 327 in the outer part 326, and one of the apertures 332 in the support member 302, thereby allowing the suspension member 304 to extend through the fastening arrangement 306 and the support member 302.

The reaction member 330 is affixed to the housing 324 by means of snap fit clips 334 which are received in slots 336 defined by the socket 328.

The barrel member 318 has an inner converging wall arrangement 338 that defines a narrowing gap 340. The spring 331 urges the carriage 314 into the narrowing gap 340.

The elongate suspension member 304 can be received by the carriage 314 through the bore 316. In the embodiment shown in FIGS. 18 to 23, the elongate suspension member 304 is a flexible elongate suspension member, such as a wire, wire rope, cable or the like.

In use, the elongate suspension member 304 is received through the bore 316 in the carriage 314, and through the aligned hole 322 and aperture 329.

As the carriage 314 is urged into the narrowing gap 340, the balls 312 are pushed inwardly by the wall arrangement 228 into clamping engagement with the elongate suspension member 304, thereby clamping the elongate suspension member 304 to the fastening arrangement 306.

The carriage 314 has a release portion 344 for releasing the clamp members 312 from clamping the elongate suspension member 304. The release portion 344 comprises an end region of the carriage 314, which protrudes from the aperture 329. The release portion 344 may be cylindrical.

The release portion 344 extends through the hole 322 in the barrel member 318 when the elongate suspension member 304 is clamped by the clamp members 312.

The fastening arrangement 306 further includes an actuating element 346 for pressing the release portion 344. The actuating element 346 is received in the housing 324 through an opening 347 in the housing 324.

The actuating element 346 comprises snap fit projections 348 on opposite sides of the actuating element 346. The housing 324 defines slots 352 in each of the opposite sides of the housing 324. The actuating element 346 is slidably received in the housing 324, and secured therein by the receipt of each projection 348 in a respective one of the slots 352. The projections 348 slide within the slots 352 when the actuating element 346 slides within the housing 324.

The actuating element 346 comprises a push member 354 in the form of a button. The actuating element 346 further includes a support 356. The support 356 is substantially flat and extends transverse to the push member 354. In use, the support 356 is arranged substantially horizontally, and the push member 354 extends substantially vertically.

A pair of slope portions 358 extends downwardly from the support 356. Each slope portion 358 has a lower sloping edge 359 (see FIG. 22) that engages the release portion 344 on opposite sides thereof. When the user presses the push member 356 from a non-actuating position to an actuating position. When so pushed, the actuating element 346 slides inwardly of the housing 324 from the non-actuating position.

The slope portions slide 358 slide across the release portion 344, pressing downwardly on the carriage. Thus, when the actuating element 346 is in the actuating position, the clamp members 312 are disengaged from the elongate suspension member 304. FIGS. 18, 20 and 23 show the actuating element 346 in the non-actuating position.

A spring 360 extends between the inner socket 322 and the push member 354. The spring 360 urges the actuating element 346 away from the actuating position to the non-actuating position.

The support 356 defines a slot 362 extending along the direction of movement of the actuating element 346. The slot 362 defines an open end 364 facing the elongate suspension member 304. When the actuating element 346 is pressed so that it moves to the actuating position, the elongate suspension member 304 is received in the slot 362.

The fastening arrangements 306 are secured in the respective end regions 308 by means of snap fit clips 364 provided on the opposite sides of the outer part 326 of the housing 324. The clips 364 are received in aperture 366 defined in the side walls 311 at the end region 308 of the support member.

1. A connecting apparatus comprising:
a support; and
a fastener for connecting an elongate suspension member to the support;
wherein the fastener comprises a clamp mechanism comprising a body having an internal converging wall arrangement, the converging wall arrangement defining a passage for receiving the elongate member therethrough;
the clamp mechanism further including a clamp member in the passage;
wherein the clamp member is movable along the passage in a clamping direction to clamp the elongate member.

2. (canceled)

3. (canceled)

4. A connecting apparatus according to claim 1, wherein the fastener comprises either a single clamp member or a plurality of clamp members.

5. (canceled)

6. A connecting apparatus according to claim 4, wherein the fastener comprising a spring to urge the, or each, clamp member in the direction of the inward converging of the wall arrangement to clamp the elongate member in the passage.

7. A connecting apparatus according to claim 4, further including a reaction member to apply a reaction force to the spring, wherein the spring is disposed between the reaction member and the, or each, clamp member.

8. (canceled)

9. A connecting apparatus according to claim 7, wherein the fastener comprises a carriage in which the, or each, clamp member is carried, the carriage being movable along the passage in the direction of the inward converging of the wall arrangement.

10. A connecting apparatus according to claim 9, wherein the carriage defines a through bore, whereby when the elongate member is received through the passage, the elongate member extends through the bore.

11. A connecting apparatus according to claim 9, wherein the fastener includes a release portion for releasing the, or each, clamp member from clamping the elongate member, the release portion being provided the carriage.

12. (canceled)

13. A connecting apparatus according to claim 1, wherein the fastener is received in the support.

14. (canceled)

15. A connecting apparatus according to claim 1, wherein the body has a main part and a flange portion on the main part, the flange portion engaging an end of the support.

16. A connecting apparatus according to claim 1, wherein the fastener comprises a housing arrangement in which the clamp mechanism is housed, the housing arrangement defining opposite first and second openings.

17. A connecting apparatus according to claim 16, wherein the housing arrangement comprises first and second housing portions, the first housing portion receiving a first region of the wall arrangement, and the second housing portion receiving a second region of the wall arrangement.

18. A connecting apparatus according to claim 16, wherein the wall arrangement converges towards the second opening, and the wall arrangement has a clamping region in which the, or each, clamp member clamps the elongate member, the clamping region converging from the holding region towards the second opening.

19. A connecting apparatus according to claim 1, wherein the wall arrangement has opposite clamping wall portions, the, or each, clamp member being arranged to clamp the elongate member between the opposite clamping wall portions.

20. A connecting apparatus according to claim 19, wherein the opposite clamping wall portions comprise a first clamping wall portion for engaging the elongate member, and a second clamping wall portion for urging clamp member into clamping engagement with the elongate member.

21. A connecting apparatus according to claim 1, wherein the support has a central support portion and a side support portion arranged transverse to each other, the central support portion defining an aperture through which the elongate member can be inserted when the support is in a first orientation.

22. A connecting apparatus according to claim 21, wherein the side support portion defines a second aperture through which the elongate member can be inserted when the support is in a second orientation.

23. A connecting apparatus according to claim 21, wherein the support has a return portion on a free edge of each of the side support portion, the body being disposed on the return portions when the body is received by the support.

24. A connecting apparatus according to claim 21, wherein the support has an end region, the end region defining a space to receive the fastener.

25. A suspension assembly according to claim 1 comprising a connecting apparatus and an elongate member.

26. A fastener comprising:
a clamp mechanism comprising a body having an internal converging wall arrangement, the converging wall arrangement defining a passage for receiving an elongate member therethrough;
the clamp mechanism further including a clamp member in the passage;
wherein clamp member is movable along the passage in a clamping direction to clamp the elongate member.
